(19) United States
(12) Patent Application Publication
(10) Pub. No.: US 2019/0268158 A1
(43) Pub. Date: Aug. 29, 2019

(54) SYSTEMS AND METHODS FOR PROVIDING MOBILE IDENTIFICATION OF INDIVIDUALS

(71) Applicant: General Dynamics Information Technology, Inc., Falls Church, VA (US)

(72) Inventors: Joseph Robert Lentini, Alexandria, VA (US); Ronald Richard Manley, Arlington, VA (US); John Charles Meyers, Springfield, VA (US); Avron K. Rothstein, Merrifield, VA (US)

(21) Appl. No.: 16/282,108

(22) Filed: Feb. 21, 2019

Related U.S. Application Data
(60) Provisional application No. 62/634,465, filed on Feb. 23, 2018.

(51) Int. Cl. H04L 9/32; H04L 9/30; H04L 29/06; G06K 19/06

(52) U.S. Cl. CPC H04L 9/3231; H04L 9/30; H04W 12/06; G06K 19/06037; H04L 63/0853

(57) ABSTRACT

Systems and methods are provided for authenticating a credential holder. A method includes receiving biometric data obtained from a machine-readable indicia. A data structure including biometrics is stored in the machine-readable indicia. Biometric data of the credential holder is compared with the biometric data stored in the biometric data structure. Authentication of the credential holder is performed based upon the comparison.

### CROSS-REFERENCE TO RELATED APPLICATIONS

This application claims the benefit of U.S. Application No. 62/634,465 filed Feb. 23, 2018, the disclosure of which is incorporated by reference in its entirety.

### TECHNICAL FIELD

The technical field generally relates to identification of individuals and more particularly relates to mobile or remote identification of individuals.

### BACKGROUND

Typical security systems, such as at the airport, utilize a process of visually examining a person's facial features with respect to a photograph of the person that is on a passport, driver's license, travel document, identity document, privilege document or any media where vetting is desired. Such systems may augment this process by using facial recognition for authentication purposes. When a need arises to automate the authentication of a user's face, a camera typically captures a representation of the user's face and facial recognition algorithms are used to analyze and determine whether the facial image sufficiently matches the previously stored photograph or template of the user's feature set. This can result in sizeable amounts of data being stored for uniquely identifying the user in the form of a database of photo and/or biometric data of all users and typically requires the use of a network connection and access to a database. This results in such approaches being cumbersome and resource-intensive.

### SUMMARY

In accordance with the teachings provided herein, systems, methods, apparatuses, non-transitory computer-readable medium for operation upon data processing devices are provided for authenticating an identity/privilege document and the document holder. A method includes receiving biometric data read from a machine-readable indicia. A template data structure for 1:1 biometric matching is stored in the machine-readable indicia. Biometric data of the credential holder (e.g., photograph) is compared with the received biometric data stored in the template data structure (in the machine-readable indicia). Authentication of the credential holder is performed based upon comparison of the biometric data (e.g., photograph) with the received biometric data contained in the template data structure (indicia).

As another example, a system and method include receiving biometric data being read from a machine-readable indicia. A template data structure for biometric matching is stored in the machine-readable indicia. Biometric data of the credential holder produced at a second time is compared with the biometric data stored in the machine-readable indicia to perform an authentication operation.

According to the present teachings, system and methods described below, do not require the centralized storage of biometric data. In this regard, once a machine-readable indicia, for example a QR code, is prepared using the steps described, credential validation can be accomplished by contemporaneously retrieving a biometric information about a credential holder and comparing this to biometric modality information stored within the QR code. This beneficially prevents the storage of sensitive biometric modality information in a centralized database. Optionally, while not as advantageous, portions or all of the biometric modality information can be stored in a centralized database.

According the present teachings, a method for authenticating a credential holder, is disclosed. As described in detail below, the method includes receiving first biometric data generated from a machine-readable indicia having a template data structure for storing the first biometric data. Second biometric data of the credential holder is compared with the first received biometric data stored in the machine-readable indicia. Authentication of the credential holder based upon a comparison of the second biometric data with the first biometric data contained in the machine-readable indicia is provided.

According the teachings above and below, the stored data structure contains a biometric template and can include an identifier or additional data, which can for example include, expiration date, a credential identification number, a credential holder name, a credential holder physical characteristic, and an additional biometric template. When comparing second biometric data to the first biometric data, live biometric data of the credential holder is compared with the received biometric data stored in the machine-readable indicia.

According the teachings above and below, the machine-readable indicia can include one of encrypted data, a combination of encrypted and non-encrypted data, signed data, unsigned data and combinations thereof.

According the teachings above and below, a reader for evaluating either a credential holder's contemporary biometric information or the machine-readable indicia can be a camera, a microphone, and a fingerprint sensor.

According the teachings above and below, template data representation of the first biometric data can be configured to store a biometric modality selected from the group of a facial biometric, a voice biometric, fingerprint biometric, iris biometric, EKG biometric, heart rate biometric and combinations thereof.

According the teachings above and below, the method can include using software to capture biometric modalities and storing the biometric modalities in a machine-readable indicia on a non-transitory computer readable medium. The stored biometric modalities of the machine-readable indicia with a biometric data scan is the captured from a live person. Software in the computing device is used to validate the credential against the holder.

According the teachings above and below, the machine-readable indicia includes data signed with a public/private key encryption.

According the teachings above and below, data from the encrypted machine-readable indicia is decrypted by the credential holders computing device to form decrypted data, the decrypted data from the machine-readable indicia being used to establish if the credential is authentic.

According the teachings above and below, the system captures a digital representation of the machine-readable indicia, and extracts data from the machine-readable indicia for use in authenticating the credential holder.

According the teachings above and below, the methods further can include enrolling a service client by collecting the first biometric data at a first time and storing the first biometric data in a biometric template. The biometric template is embedded in the machine-readable indicia for future credential holder authentication. The credential holder is authenticated by comparing the biometric template with its associated machine-readable indicia at a second time.

According the teachings above and below, the methods further can include displaying on a computer screen, the machine-readable indicia which can include an encrypted token. A digital image of a credential holder is then captured and used to form second biometric data. The credential holder is validated by comparing the first biometric data with the second biometric data. If the first biometric data and second biometric data match, a token is displayed and used to secure access to a facility or computer.

According to the present teachings, a method for authenticating a credential holder, is presented. The method includes capturing a first image of an anatomical feature of the credential holder. A first biometric data representative of the first image is stored in a QR-code having a template data structure for storing a representation of the first biometric data on a credential. The method includes capturing a second image of an anatomical feature of the credential holder and storing a second biometric data representative of the credential holder at a second time. Upon the presentation of the credential by the credential holder, the second biometric data is compared with the first biometric data stored in the machine-readable indicia. Authentication of the credential holder is based upon a comparison of the second biometric data with the first biometric data is presented. According to the present teachings disclosed above or below, the template data structure can include a 1:N representation of the biometric data.

According to the present teachings disclosed above or below, a system for authenticating a credential holder includes a storage device for storing instructions. A processor is included which is configured to execute the instructions to receive live or contemporaneous biometric data from a machine-readable indicia having a template data structure for storing biometric matching data. The processer is further configured to compare the live or contemporary biometric data of the credential holder with the received biometric data stored in the template data structure. The processor is further configured to provide a signal indicative of the authentication of the credential holder based upon comparison of the live or contemporaneous biometric data with the stored and received biometric data contained in the template data structure.

According to the present teachings disclosed above or below, the system or method includes a non-transitory computer readable medium, having stored thereon instructions for authenticating a credential holder that, when executed, cause one or more data processors to receive first biometric data generated from a machine-readable indicia having a template data structure for storing the first biometric data. The one or more data processors are configured to compare live or contemporaneous biometric data of the credential holder with the received first biometric data stored in the template data structure. Further, the one or more data processors are configured provide authentication of the credential holder based upon comparison of the live biometric data with the received biometric data contained in the template data structure.

According to the present teachings disclosed above or below a method for authenticating a credential holder includes capturing a first image of an anatomical feature of the credential holder.

According to the present teachings disclosed above or below, a method for authenticating a credential holder further includes storing a first biometric data representative of the first image in a QR-code having a template data structure for storing a representation of the image on a credential. The method includes capturing a second image of an anatomical feature of the credential holder at a second time. Upon the presentation of the credential by the credential holder, comparing the second biometric data with the representation of the image stored in the QR-code. Authentication of the credential holder is provided based upon a comparison of the second biometric data with the representation of the image.

### DESCRIPTION OF THE DRAWINGS

FIG. 1 is a block diagram depicting a biometric identification system;

FIGS. 2-5 depict examples of identification codes associated with two-dimensional biometric data structures;

FIG. 6 is a flow chart depicting biometric authentication of both the credential holder and the physical credential;

FIG. 7 is a flow chart depicting authentication without a physical credential;

FIG. 8 is a flow chart depicting retrieval of a digital biometric template;

FIG. 9 is a flow chart depicting remote biometric authentication;

FIG. 10 is a flow chart depicting remote biometric authentication single or multi-factor; and

FIG. 11 is a block diagram depicting an example of another configuration for a biometric identification system.

### DETAILED DESCRIPTION

The following detailed description is merely exemplary in nature and is not intended to limit the application and uses. Furthermore, there is no intention to be bound by any expressed or implied theory presented in the preceding technical field, background, brief summary, or the following detailed description.

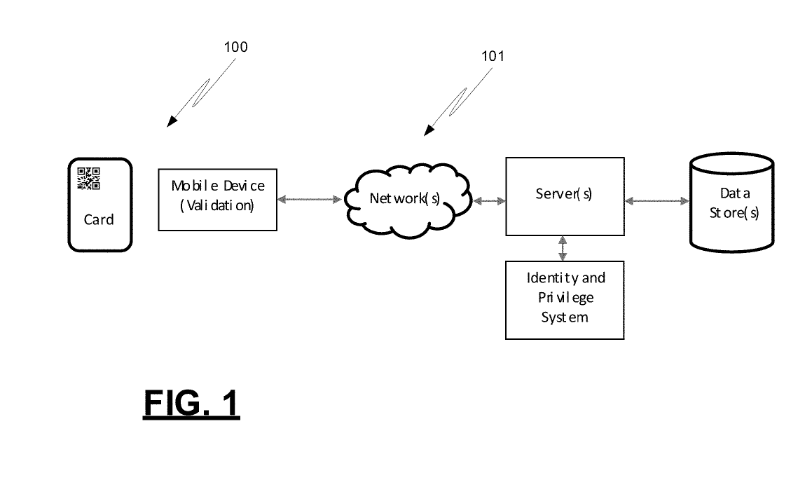

FIG. 1 depicts at 100 the credential of a user who is being authenticated by the holder of a mobile device held by an individual with validation authority in order to satisfy security requirements of a location (e.g., an airport). One or more physical attributes of a user can be used to determine whether the user is really the person associated with the physical credential. The physical attributes or biometrics can range from facial features to voice, fingerprint, or any other individual biometric etc.

The physical attributes of the user are captured live by the mobile device and compared to the biometric that is stored in the visible indicia on the user's credential. The identification credential contains previously stored biometric data about the user, such as user facial features, fingerprint, voice, etc., in a visible or invisible indicia. To reduce the size of the stored biometric data in the indicia, the data is stored efficiently according to a biometric template.

Optionally, at 101, a identity and privilege system is remotely accessible over network(s) and server(s) and processes the data received (directly or indirectly) from the mobile device. For example, the user's identity is confirmed by the mobile device and transmitted to the Identity and Privilege System. The system determines that the user's credential has not been revoked and is still valid, and provides security privilege information (e.g., airport access is allowed) back to the mobile device or to a facility component (e.g., an automated access gate).

It should be understood that embodiments can be configured differently from the configuration depicted in FIG. 1. For example, offline confirmation of the credential authenticity and biometric 1:N match can be conducted fully offline and use a Revocation List stored on the mobile device. Throughout the application, it should be understood N in this context can be one or more. Further, the identification system can be used in many different areas, including TSA access points, hotel check-ins, election voter identification, etc. In such uses, it can help allow security personnel to determine whether the document presented is authentic and that the person presenting the document is the rightful owner. It further provides an effective biometric validation against fraud and can be integrated into existing programs with minimal effort.

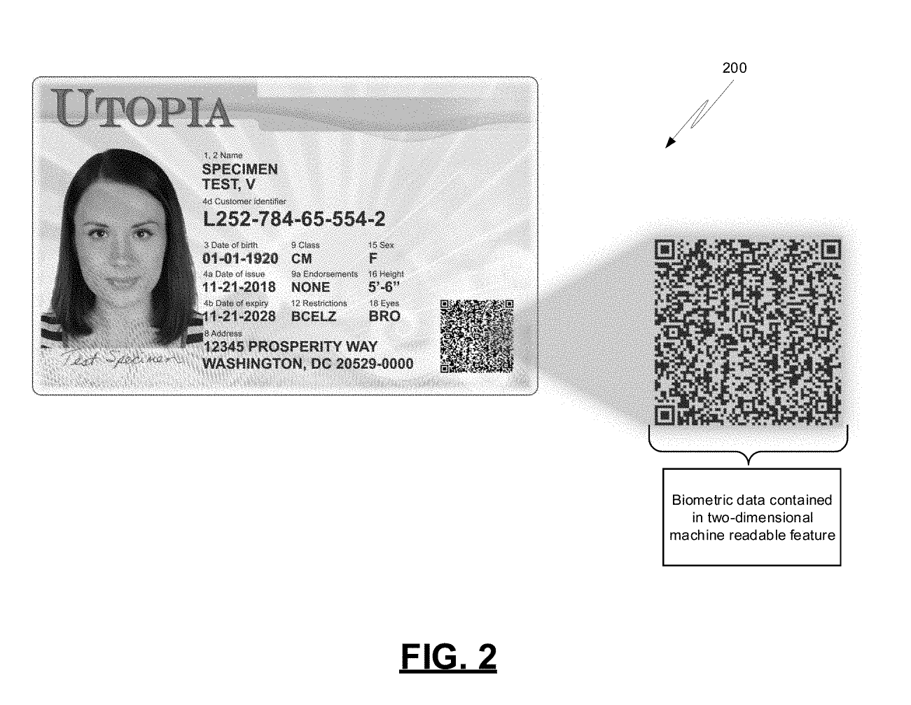

FIGS. 2-5 depict examples of identification codes associated with biometric templates. With reference to FIG. 2, an identification card is shown at 200 with a photograph of a credential holder. The indicia on the card is a QR (Quick Response) code that contains biometric data. The biometric data has been stored in the QR code according to a pre-specified biometric template. In this example, the biometric template is included in the data structure stored in the QR code. A smaller data structure for storing biometric data (e.g., facial feature data, fingerprint data, voice data, etc., representative of the credential holder) allows for a more efficient recognition process in authenticating the credential holder. As an illustration, the biometric template could be less than 500 bytes. In other embodiments, the size of the QR code can be adjusted to accommodate more data bytes.

For credentialing applications, the QR code typically does not exceed a square of 2.0 inches per side and is typically smaller. For applications that use a computer screen or monitor, or paper document, the QR code could be much larger. With high level error correction (30% loss recovery possible), a 101×101 module QR code can hold approximately 403 Bytes. With low error correction (7% loss recovery possible), the same QR code can hold approximately 929 bytes. For additional security, the data in the QR code could be encrypted. Physical size, number of modules, data format and data content of the QR code can all be configured to the application.

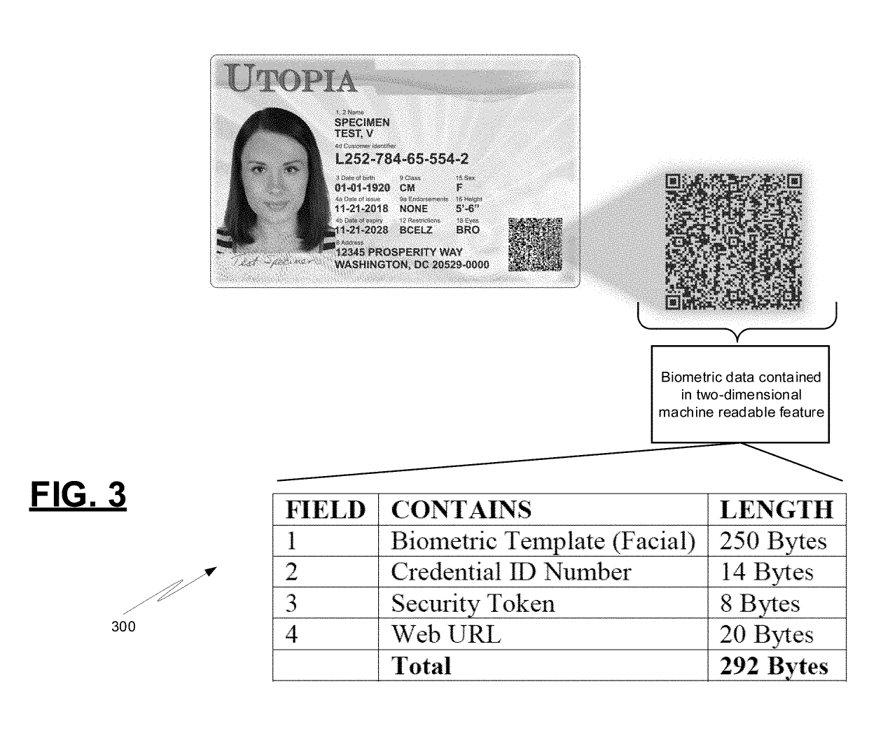

The QR code may contain only the biometric template. However, it should be understood that embodiments can also include the QR code containing additional information beyond the biometric template, with encryption applied to individual fields or the entire set of data. FIG. 3 provides an example of the template data structure containing the facial features of a credential holder as well as additional information. In this example, there are four fields: the biometric template used to store the biometric data; credential ID number to identifier the user; security token data; and a web URL. The length of each field is relatively short. The biometric template field in this example is 250 bytes. The credential ID number field is 14 bytes. The security token field is 8 bytes. The Web URL field is 20 bytes. Although the total size is 292 bytes, the stored biometric data is sufficient for 1:1 facial matching through a mobile device. This allows for a 1:N biometric check in addition to additional data examination. This is more effective than using the photograph on the card for biometric comparison because the photograph cannot be encrypted, is more easily altered, and must be converted to a template for 1:N comparison. This is more efficient than using a biometric database for the comparison because having a local copy of the template allows offline 1:1 matching, no back-end database, and does not require a network connection.

Using the data stored in the template data structure and the live biometric data, different facial recognition algorithms can be used to determine if a facial recognition match exists for authentication purposes. As examples, facial recognition algorithms from the following companies can be used: Secure Planet; Innovatrics; 3M Cogent; Cognitec; Aware, Inc.; NEC; Neurotechnology; and SuperCom Ltd.

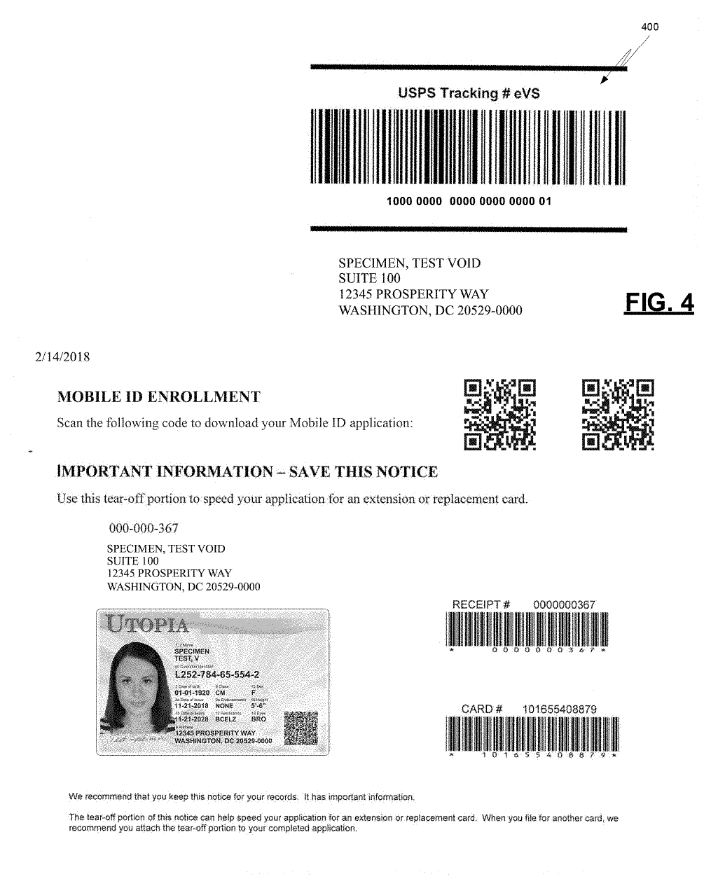

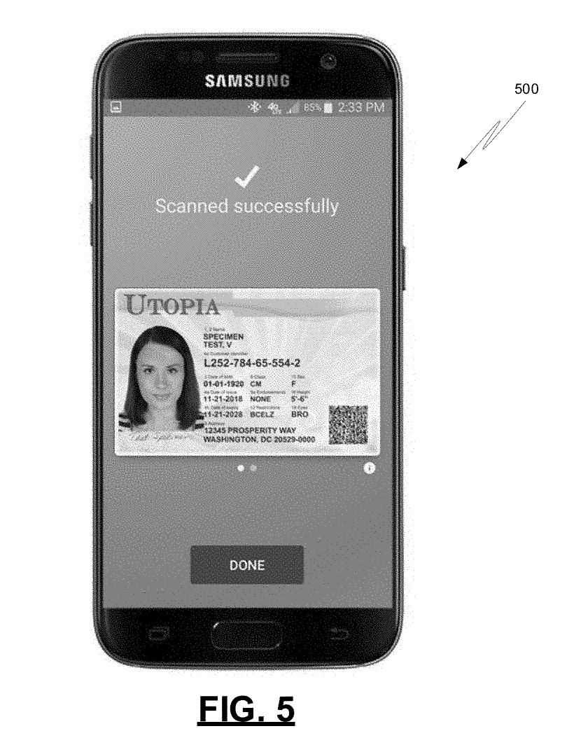

FIG. 4 illustrates at 400 that the template data structure can be placed on other medium such as a document that contains a QR code as shown in the figure. The application authenticates the document holder by a 1:N biometric match using the template contained in the QR code. Once the system authenticates the credential holder, the mobile device that scanned the QR code receives confirmation of the authentication process as shown on FIG. 5 at 500.

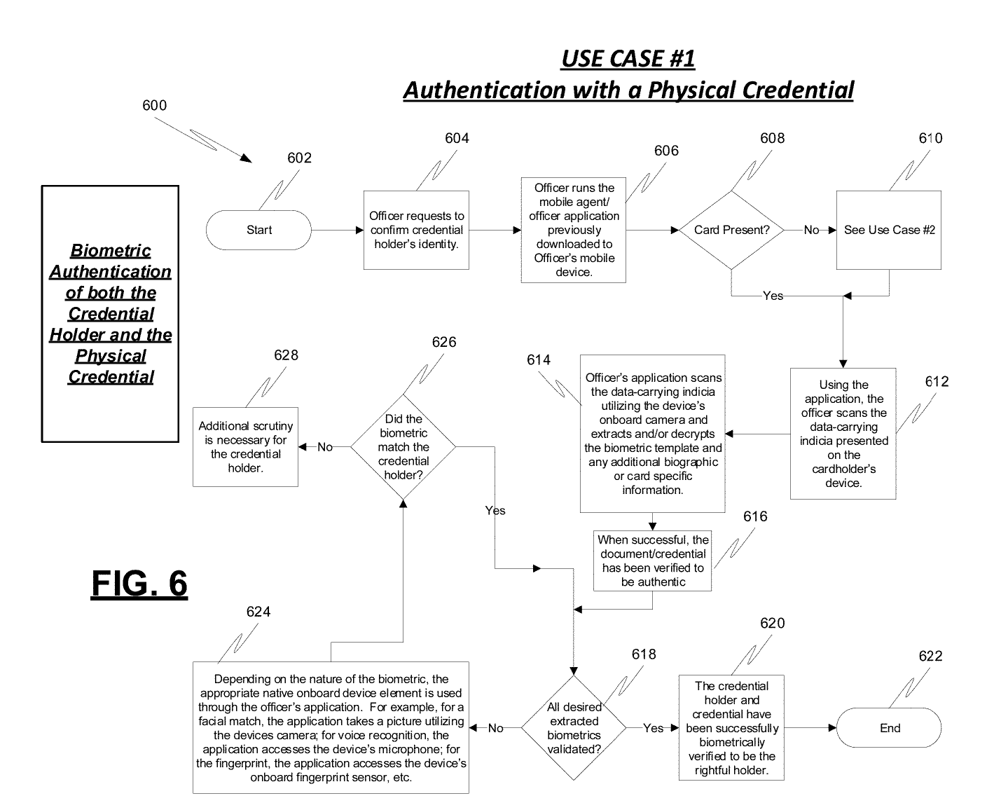

FIG. 6 is a flow chart depicting at 600 biometric authentication of both the credential holder and the physical credential. This scenario involves authentication with a physical credential. Start indicator block 602 indicates that processing for this scenario begins at process block 604 where a security officer requests the system to confirm a credential holder's identity. At process block 606, the officer runs the mobile ID application that was previously downloaded to the officer's mobile device. If the credential holder has not presented a card as determined at decision block 608, then processing continues at process block 610. However, if the card is present, then processing continues at process block 612 where the officer uses the application to scan the data-carrying indicia (machine-readable indicia, such as a QR code) that was presented on the cardholder's device. The officer's application scans the data-carrying indicia by utilizing the device's onboard camera at process block 614. Additionally, the application extracts and/or decrypt the biometric template and any additional biographic or card specific information. Process block 616 allows the credential to be verified to be authentic when a successful result has been achieved.

Decision block 618 examines whether all desired extracted biometrics have been validated. If they have, process block 620 provides an indication that the credential holder and credential have been successfully verified, and processing ends at 622. However, if not all desired extracted biometrics have been validated at decision block 618, then processing continues at process block 624. At process block 624, the appropriate native onboard device element is used through the officer's application based upon the nature of the biometric. For example, for a facial match, the application takes a picture utilizing the devices camera. For voice recognition, the application accesses the device's microphone. For fingerprint recognition, the application accesses the device's onboard fingerprint sensor.

After process block 624 completes, decision block 626 examines whether the biometric matched the live biometric of the credential holder. If it did not, process block 628 indicates that additional scrutiny is necessary for the credential holder. However, if there was a match, then processing continues at decision block 618 until all desired extracted biometrics and been validated.

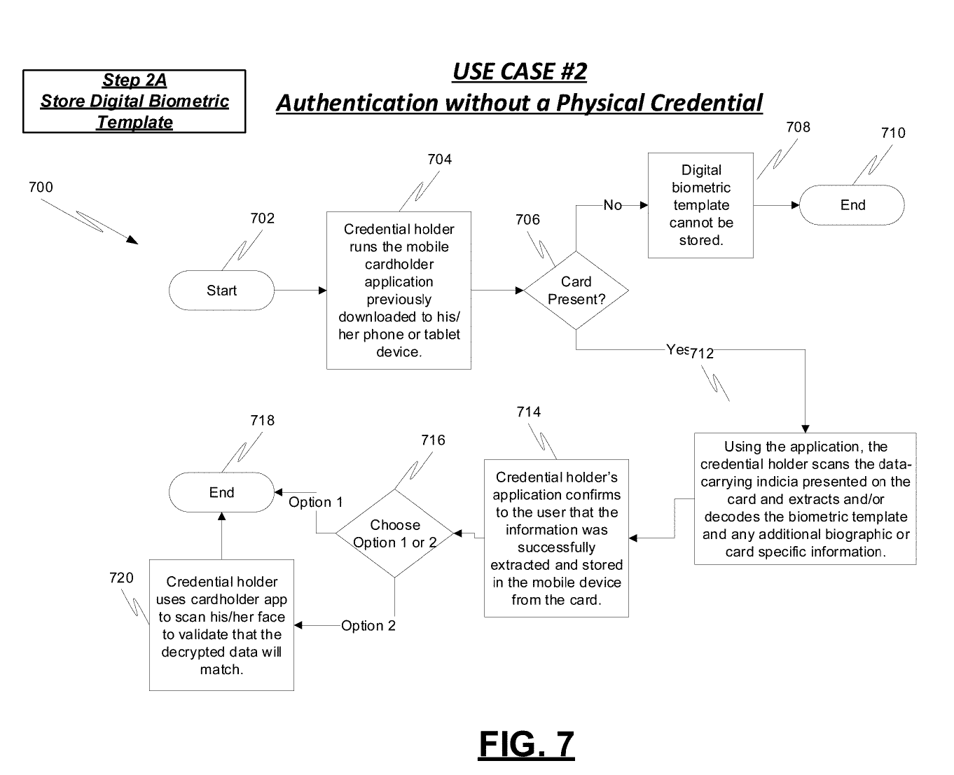

FIG. 7 is a flow chart depicting storing digital biometric template for scenarios involving authentication x a physical credential. Start block 702 indicates that processing begins at 704 where a credential holder runs a mobile cardholder application previously downloaded to their mobile device. If a card is not presented by the credential holder as determined by decision block 706, then a digital biometric template cannot be stored as indicated by process block 708 and processing ends at 710. However, if a card is present, then processing continues at process block 712. At process block 712, the credential holder uses the application and scans the data-carrying indicia presented on the card and extracts and/or decrypts the biometric template and any additional biographic or card specific information.

At process block 714, the credential holder's application confirms to the user that the information was successfully extracted and stored in the mobile device from the card. Depending upon which option the credential holder selects at decision block 716, processing continues at 718 or 720. If option 1 has been selected, processing ends at 718. If option 2 has been selected, the credential holder uses the application to scan their face to validate that the decrypted data matches. Processing then terminates at 718.

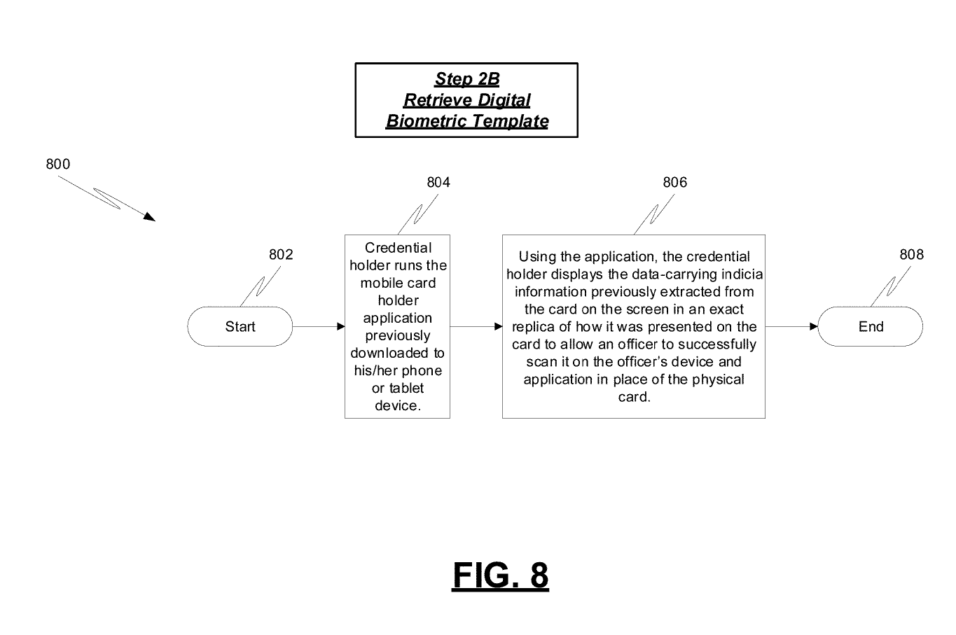

FIG. 8 is a flow chart depicting retrieval of a digital biometric template. Processing begins at 802 for this scenario. At process block 804, a credential holder runs the mobile card holder application previously downloaded to their mobile device. Using the application at process block 806, the credential holder displays the data-carrying indicia information previously extracted from the card on the screen in an exact replica of how it was presented on the card. This is to allow an officer to successfully scan it on the officer's device and application in place of the physical card. Processing for this scenario ends at 808.

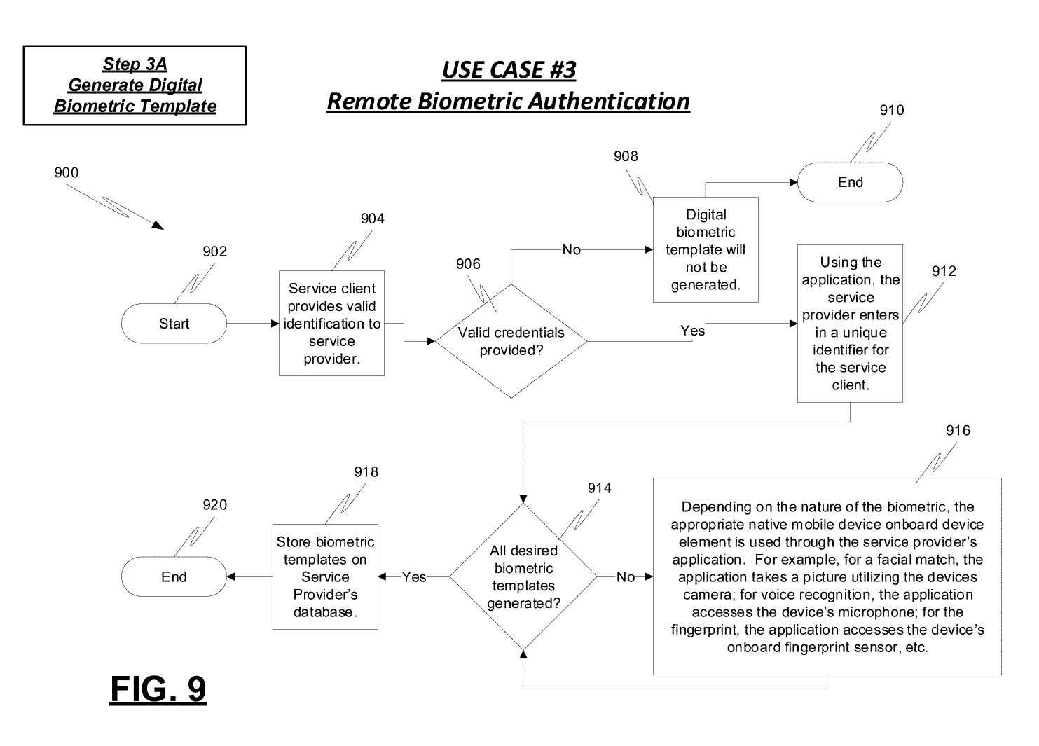

FIG. 9 is a flow chart depicting remote biometric authentication where a digital biometric template is generated. Start block 902 indicates that processing for this scenario begins at process block 904 where a service client provides valid identification to a service provider. If valid credentials are not provided as determined at decision block 906, then a digital biometric template will not be generated as indicated at 908 and processing for this scenario terminates at 910. However, if valid credentials are provided, then processing continues at 912.

At process block 912, the service provider using the application enters in a unique identifier for the service client. If all desired biometric templates have not been generated as determined at decision block 914, then processing continues at process block 916. At process block 916, the appropriate native mobile device onboard device element is used through the service provider's application depending on the nature of the biometric. For example, for a facial match, the application takes a picture utilizing the devices camera. For voice recognition, the application accesses the device's microphone. For fingerprint recognition, the application accesses the device's onboard fingerprint sensor.

When all desired biometric templates have been generated as determined at 914, process block 918 stores the biometric templates in the service provider's database. Processing then terminates at 920 for this scenario.

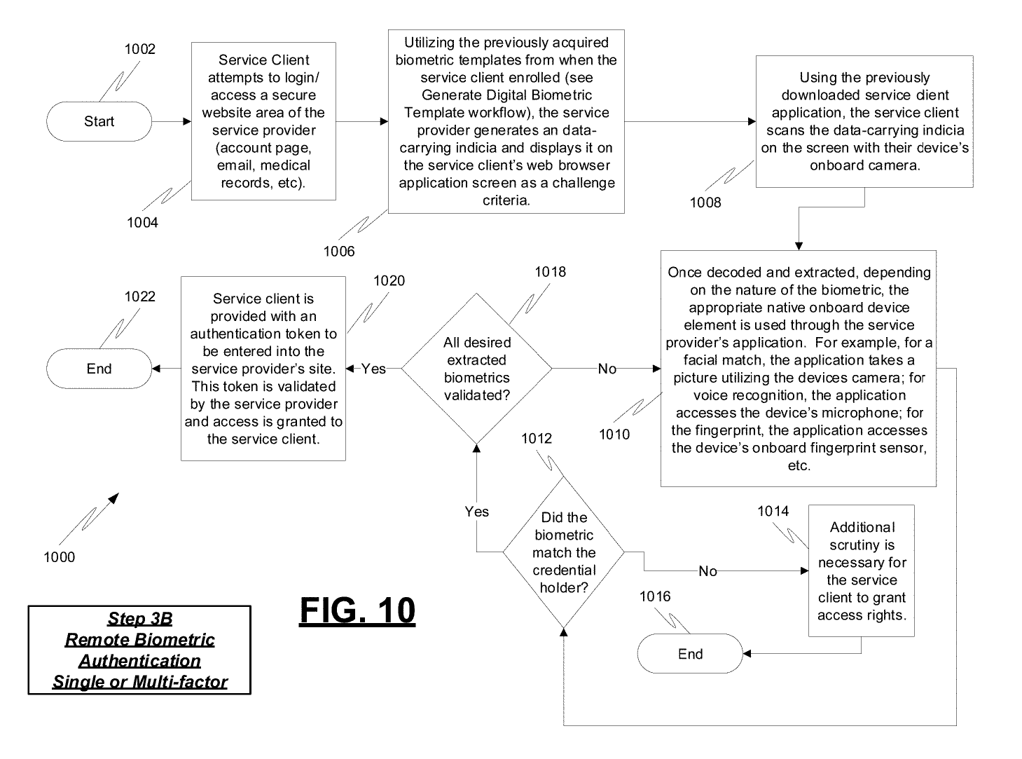

FIG. 10 is a flow chart depicting remote biometric authentication single or multi-factor. Start block 1002 indicates that processing begins at 1004 where a service client attempts to login or access a secure website area of the service provider (e.g., an account page, email, medical records, etc.). Utilizing the previously acquired biometric templates from when the service client enrolled, the service provider generates at process block 1006 data-carrying indicia and displays it on the service client's web browser application screen as a challenge criteria.

Using the previously downloaded service client application, the service client scans at process block 1008 the data-carrying indicia on the screen with their device's onboard camera. Once decoded and extracted and depending on the nature of the biometric, the appropriate native onboard device element is used at 1010 through the service provider's application. For example, for a facial match, the application takes a picture utilizing the devices camera. For voice recognition, the application accesses the device's microphone. For fingerprint recognition, the application accesses the device's onboard fingerprint sensor.

If the biometric did not match the credential holder as determined at decision block 1012, then process block 1014 indicates that additional scrutiny is necessary for the service client to grant access rights, and processing for this scenario terminates at 1016. However, if the biometric did match as determined at 1012, then decision block 1018 examines

whether all desired extracted biometrics have been validated. If they had not, then processing resumes at process block 1010. If all desired extracted biometrics have been validated as examined at decision block 1018, then the service client is provided at process block 1020 with an authentication token to be entered into the service provider's site. This token is validated by the service provider and access is granted to the service client. Processing then terminates for this scenario at 1022.

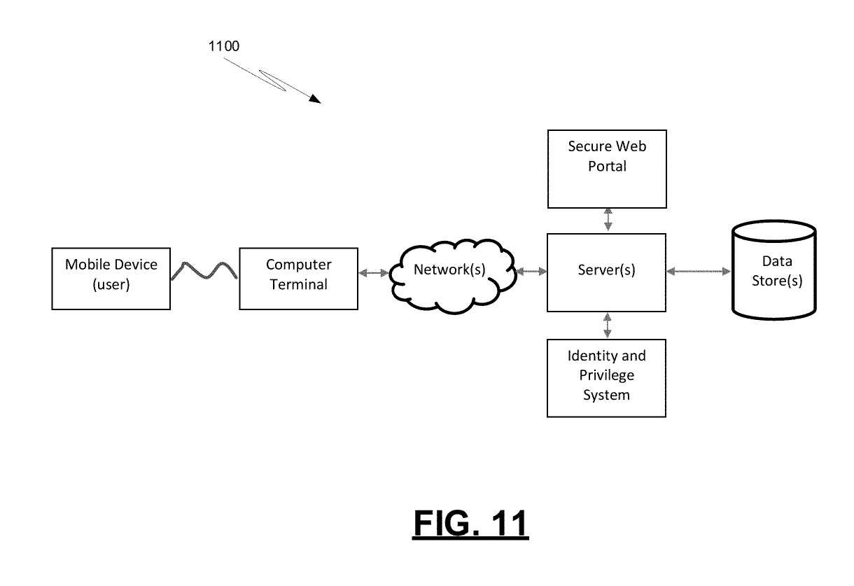

FIG. 11 is a block diagram depicting at 1100 an example of another configuration for a biometric identification system. In this case, a user attempting to access a secure web portal is presented with a QR code on the computer terminal. This is so the web portal can prove the identity of the user prior to granting access. The user scans the code with a provisioned application that provides a one-time use access code if the user can complete a 1:1 biometric match using their mobile device. The user types the code into their computer terminal to access the online service.

As described above, the method for authenticating a credential holder, can include receiving first biometric data generated from a machine-readable indicia having a template data structure for storing the first biometric data. This can include using a reader such as a CCD camera or microphone to capture an image of a visual or nonvisual biometric modality and imprint it on or in a readable media such as a QR-Code. This imprinted code can store, by way of a non-limiting example a 1:1, 1:N, or other representation of a biometric modality. The method then can include retrieving and comparing a second set of biometric data of the credential holder with the first received biometric modality or data stored in the machine-readable indicia. As described below, this can include the contemporaneous or live retrieval of biometric modalities associated with the credential holder. After the comparison step, an authentication of the credential holder based upon a successful comparison. This authentication can take the form of a code which can be input into, by way of non-limiting example, a mobile communication device or computer terminal or a signal indicative of the positive authentication.

The stored data structure can contain a biometric template that can store various types of identification information such as, by way of non-limiting example, a credential identification number, a credential holder name, a credential holder physical characteristic, and an additional biometric template. When comparing the second biometric data is compared to the first biometric data, the second biometric data can be live or contemporaneous biometric data of the credential holder. The machine-readable indicia can include encrypted data, a combination of encrypted and non-encrypted data, signed data, unsigned data and combinations thereof. Signed data can be, by way of non-limiting example, data signed using private-public key encryption.

The second biometric data of the credential holder is obtained by using a reader on a computing device to capture or retrieve the biometric modalities associated or in parallel with the machine-readable indicia and then using a program in the computing device to compare data from the machine-readable indicia with a contemporarily captured biometric data of the credential holder. The reader can be, by way of non-limiting example, a camera, a microphone, and a fingerprint sensor configured to capture biometric modalities of a credential holder. The data captured can include, by way of non-limiting example, a facial biometric, a voice biometric, fingerprint biometric, iris biometric, EKG biometric, heart rate biometric, and combinations thereof.

The machine-readable indicia can be a digital version of the machine-readable indicia read by the computing device and used to provide the template for biometric comparison to the live credential holder. Additionally, the machine-readable indicia can be printed on a substrate such as card stock, paper, plastic, or metal. Additionally, the indicia can be printed onto an identification credential, and an indicia displayed on an electronic display on a mobile communication device such as a phone or a tablet.

To form the second biometric data, a live image of an anatomical or auditory feature and converted into a representation of the indicia. This representation of the indicia can be stored on a non-transitory computer readable medium. The representation of the indicia is then compared with a predefined stored image biometric data scan previously captured from a live person. Using software in the computing device the comparison is used to validate the credential against the holder. Optionally, the machine-readable indicia includes data signed with a public key encryption. The encrypted machine-readable indicia can be decrypted by the credential holders computing device or mobile communication device to form decrypted data. The decrypted data from the machine-readable indicia is used to establish if the credential is authentic.

The system and methods described above, do not require the centralized storage of biometric data. In this regard, once a QR code is prepared using the steps described above, credential validation can be accomplished by contemporaneously retrieving a biometric information about a credential holder and comparing this to biometric modality information stored within the QR code. This beneficially prevents the need for storage of sensitive biometric modality information in a centralized database. Optionally, while not as advantageous, portions or all of the biometric modality information can be stored in a centralized database.

To enroll a credentialed user, a service client collects the first biometric data or modalities at a first time. These biometric modalities are used to create first biometric data which is stored in a biometric template in the biometric indicia. For future credential holder authentication, the indicia held by the credential holder is compared with the a contemporaneously calculated biometric modality of with its associated machine-readable indicia at a second time. The machine-readable indicia can be displayed on a computer screen and can include an encrypted token. The credential holder is validated by comparing the first biometric data with the second biometric data. If the first biometric data and second biometric data match, a token is displayed on a mobile device. The token can then be input into a secure portal to complete the secure login.

In another embodiment, system for authenticating a credential holder can include a storage device for storing instructions, and a processor configured to execute the instructions. The processor has software configured to receive biometric data from a machine-readable indicia that has a template data structure for storing biometric matching data. This information is compared with live biometric data of the credential holder. Based on the results of a comparison, the processor can provide a signal indicative of the authentication of the credential.

In another embodiment, system for authenticating a credential holder can include a non-transitory computer readable medium, having stored thereon instructions or software for authenticating a credential holder. The software, when executed, causes one or more data processors to receive first biometric data generated from a machine-readable indicia having a template data structure for storing the first biometric data. The software compares live or recent or cotemporally captured biometric data of the credential holder with the received first biometric data stored in the template data structure of the indicia. An authentication signal of the credential holder is provided is based upon comparison of the live biometric data with the received biometric data contained in the template data structure.

In another embodiment, the method for authenticating a credential holder can include storing a first biometric data representative of the credential holder at a first time on a first machine-readable indicia such as a QR-code having a template data structure for storing a representation of the first biometric data, creating a QR code having a one-time session use token, presenting the QR code on a display, copying the QR code with a mobile device. (public key) unlock data—signed properly trust data integrity.

The first biometric data can include data from a first image of an anatomical feature of the credential holder. This data which is preferably stored as an indicia on a physical object, can also be stored at a central repository or on a credential holders mobile communication device, or alternatively not stored centrally at all. A second biometric data representative of the credential holder at a second time is at least temporarily stored in non-transitory memory and compared to the first biometric data. The formation of the second biometric data includes capturing a second image of an anatomical feature of the credential holder using a camera associated with a mobile device.

Upon the presentation of the credential having the first machine-readable indicia by the credential holder, the second biometric data is compared with the first biometric data stored in the machine-readable indicia. An authentication of the credential holder based upon a comparison of the second biometric data with the first biometric data contained in the machine-readable indicia is provided. Optionally, the first biometric data representative of the credential holder can be stored on a non-transitory computer readable medium.

In another embodiment, method for authenticating a credential holder can include capturing a first image of an anatomical feature of the credential holder. First biometric data representative of the first image is stored in a QR-code having a template data structure. A second image of an anatomical feature of the credential holder is captured and stored at a second time. Upon the presentation of the credential by the credential holder, the second biometric data is compared with the first biometric data stored in the machine-readable indicia. Authentication of the credential holder is provided based upon a comparison of the second biometric data with the first biometric data. This authentication of the credential holder can include by way of non-limiting example sending the QR-code to a terminal or reading the QR-code using a mobile computing device. In this regard, capturing a second image of an anatomical feature of the credential holder can include using a camera associated with one of a mobile device and a computer kiosk. The second biometric data is calculated on mobile device, thus eliminating the need for centralized storage of the biometric data.

While at least one example embodiment has been presented in the foregoing detailed description, it should be appreciated that a vast number of variations exist. It should also be appreciated that the embodiment or embodiments are only examples, and are not intended to limit the scope, applicability, or configuration of the disclosure in any way. Rather, the foregoing detailed description will provide those of ordinary skill in the art with a convenient road map for implementing the example embodiment or embodiments. It should be understood that various changes can be made in the function and arrangement of elements without departing from the scope of the disclosure as set forth in the appended claims and the legal equivalents thereof.

As an example of the wide variations of the systems and methods described herein, the systems and methods can be used in the following areas: Medicare fraud protection; employment eligibility verification; financial loan application; landlord/renter verification; court/notary verification; medical records access from provider; secure email access from employer/government; and bank account access. The following illustrates several of these applications. A system and method can be used in hospitals/urgent care/private medical practices for secure remote medical records access for patients. This can strengthen HIPAA compliance by adding a biometric verification for patients on top of any standard username/password. As another example, a system and method can be used for government/commercial entities and provide a live biometric verification addition/replacement for secure remote email/terminal access. This can complement a cryptologic token (e.g., RSA) with username/password. As yet another example, Permanent Resident Card (PRC)/Employment Authorization Document (EAD) cards could be configured to use a QR code or other machine-readable indicia to allow a secure application on a mobile device to validate a credential based upon the systems and methods described herein.

Additionally, the systems' and methods' data (e.g., associations, mappings, data input, data output, intermediate data results, final data results) may be stored and implemented in one or more different types of computer-implemented data stores, such as different types of storage devices (e.g., RAM, ROM, Flash memory) and programming constructs (e.g., flat files, databases, programming data structures, programming variables, IF-THEN (or similar type) statement constructs). It is noted that data structures describe formats for use in organizing and storing data in databases, programs, memory, or other computer-readable media for use by a computer program.

Still further, the systems and methods may be provided on many different types of computer-readable storage media including computer storage mechanisms (e.g., non-transitory media, such as CD-ROM, diskette, RAM, flash memory, computer's hard drive) that contain instructions (e.g., software) for use in execution by a processor to perform the methods' operations and implement the systems described herein.

It is claimed:

1. A method for authenticating a credential holder, comprising:
receiving first biometric data generated from a machine-readable indicia having a template data structure for storing the first biometric data;
comparing second biometric data of the credential holder with the first received biometric data stored in the machine-readable indicia; and
providing authentication of the credential holder based upon a comparison of the second biometric data with the first biometric data contained in the machine-readable indicia.

2. The method of claim 1, wherein the stored data structure contains a biometric template and at least one of, a credential identification number, a credential holder name, a credential holder physical characteristic, and an additional biometric template; and
wherein the comparing second biometric data includes comparing live biometric data of the credential holder with the received biometric data stored in the machine-readable indicia.

3. The method of claim 1, wherein the machine-readable indicia includes one of encrypted data, a combination of encrypted and non-encrypted data, signed data, unsigned data and combinations thereof.

4. The method of claim 1, wherein comparing second biometric data of the credential holder is accomplished by using a reader on a computing device to capture the machine-readable indicia and then using a program in the computing device to compare data from the machine-readable indicia with a captured biometric data of the credential holder.

5. The method of claim 4, wherein the reader includes one of a camera, a microphone, and a fingerprint sensor.

6. The method of claim 1, wherein the first biometric data is extracted from the machine-readable indicia using the computing device, and a second biometric template is created using a live credential holder's biometric data;
wherein the computing device compares the first biometric data with the live credential holder's second biometric template and determines whether a match exists.

7. The method of claim 1, wherein the biometric information is one of a biometric template or direct biometric data; and
wherein the machine-readable indicia is one of an indicia printed on a substrate, an indicia printed onto an identification credential, and an indicia displayed on an electronic display.

8. The method of claim 1, wherein the template data representation of the first biometric data is configured to store a biometric modality.

9. The method of claim 8, wherein the biometric modality is a biometric modality selected from the group of a facial biometric, a voice biometric, fingerprint biometric, iris biometric, EKG biometric, heart rate biometric and combinations thereof

10. The method of claim 1, wherein the machine-readable indicia comprises data signed with a public key encryption.

11. The method of claim 10, wherein the data from the encrypted machine-readable indicia is decrypted by the credential holders computing device to form decrypted data, the decrypted data from the machine-readable indicia being used to establish if the credential is authentic.

12. The method of claim 1, further comprising enrolling a service client by collecting the first biometric data at a first time and creating biometric templates;
embedding the biometric template in the machine-readable indicia
for future credential holder authentication;
authenticating the credential holder by comparing the biometric template with its associated machine-readable indicia at a second time;
displaying the machine-readable indicia on a computer screen, the machine-readable indicia includes an encrypted token;
capturing a digital image of the indicia to provide second biometric data;
validating the credential holder by comparing the first biometric data with the second biometric data; and
if the first biometric data and second biometric data match, displaying a token on a mobile device; and
entering the token into a secure portal to complete the secure login.

13. The method of claim 1 wherein the template data structure comprises a 1:N representation of the biometric data.

14. A method for authenticating a credential holder, comprising:
storing a first biometric data representative of the credential holder at a first time on a first machine-readable indicia having a template data structure for storing a representation of the first biometric data;
storing a second biometric data representative of the credential holder at a second time;
upon the presentation of the credential having the first machine-readable indicia by the credential holder, comparing the second biometric data with the first biometric data stored in the machine-readable indicia; and
providing authentication of the credential holder based upon a comparison of the second biometric data with the first biometric data contained in the machine-readable indicia.

15. The method according to claim 14 further comprising storing the first biometric data representative of the credential holder on a non-transitory computer readable medium.

16. The method according to claim 14 wherein the first machine-readable indicia is a QR-code.

17. The method according to claim 14 wherein storing a first biometric data includes capturing a first image of an anatomical feature of the credential holder.

18. The method according to claim 14 wherein providing authentication of the credential holder includes creating a QR code having a one-time session use public key token, presenting the QR code on a display, copying the QR code with a mobile device.

19. A method for authenticating a credential holder, comprising:
capturing a first image of an anatomical feature of the credential holder;
storing a first biometric data representative of the first image in a QR-code having a template data structure for storing a representation of the first biometric data on a credential;
capturing a second image of an anatomical feature of the credential holder storing a second biometric data representative of the credential holder at a second time;
upon the presentation of the credential by the credential holder, comparing the second biometric data with the first biometric data stored in the machine-readable indicia; and
providing authentication of the credential holder based upon a comparison of the second biometric data with the first biometric data.

20. The method according to claim 19 wherein providing authentication of the credential holder includes one of sending the QR-code to a terminal and reading the QR-code using a mobile computing device.

21. The method according to claim 19 wherein storing a second biometric data includes capturing a second image of an anatomical feature of the credential holder using a camera associated with one of a mobile device and a computer kiosk.

22. The method according to claim 19 wherein the second biometric data is calculated on mobile device.
